(19) United States
(12) Patent Application Publication
(10) Pub. No.: US 2026/0177258 A1
(43) Pub. Date: Jun. 25, 2026

(54) FRESH AIR PURIFICATION WINDOW

(71) Applicant: GUANGDONG HONGBANG METAL MANUFACTURING CO., LTD., Guangdong (CN)

(72) Inventor: HONGMING PI, HUANGGANG (CN)

(21) Appl. No.: 19/001,029

(22) Filed: Dec. 24, 2024

(30) Foreign Application Priority Data
Dec. 25, 2023 (CN) 202323530538.7
Apr. 19, 2024 (CN) 202420822113.9
Nov. 19, 2024 (CN) 202422820726.1

(51) Int. Cl. F24F 7/003

(52) U.S. Cl. CPC F24F 7/003; F24F 2221/20

(57) ABSTRACT

Disclosed is a fresh air purification window, including a window frame main body. The window frame main body is provided with a groove, an open end of the groove is covered with a surface cover, a side of the groove close to an exterior is provided with an air inlet, a side of the groove close to an interior is provided with an air outlet, an air purification module is arranged inside the groove, an air inlet end of the air purification module is in communication with the air inlet, and an air outlet end of the air purification module is in communication with the air outlet. The present disclosure improves an air quality of the interior, an overall structure cannot affect a lighting effect of the window, an appearance is simple and aesthetic, and it is also convenient for maintenance and replacement of the air purification module.

### TECHNICAL FIELD

The present disclosure relates to the technical field of windows, and in particular to a fresh air purification window.

### BACKGROUND

In recent years, air pollution has become increasingly severe, and people's demands for life have become higher and higher. Traditional windows cannot meet people's high-quality life, so fresh air purification windows are becoming increasingly popular.

In the prior art, the present disclosure with a publication number “CN205536149U” discloses a fresh air purifier. A mounting bracket is arranged on an inner frame of a fixed end window and an open end window, an inner side of the mounting bracket is provided with a transparent plate, and an outer side of the mounting bracket is provided with a purifier main body.

Although a structure of the fresh air purifier is simple, it is convenient to mount for different windows and has a good purification effect. However, the purifier main body blocks light, which affects a lighting effect of a window, and the purifier main body is separated from the window, which affects the overall aesthetics.

### SUMMARY

In order to overcome the defects of the prior art, the present disclosure provides a fresh air purification window that does not affect lighting and aesthetics.

The technical solution adopted by the present disclosure to solve the technical problems is as follows:
Provided is a fresh air purification window, including a window frame main body. The window frame main body is provided with a groove, an open end of the groove is covered with a surface cover, a side of the groove close to an exterior is provided with an air inlet, a side of the groove close to an interior is provided with an air outlet, an air purification module is arranged inside the groove, an air inlet end of the air purification module is in communication with the air inlet, and an air outlet end of the air purification module is in communication with the air outlet.

In some embodiments, the air outlet is arranged on a side wall of the groove.

In some embodiments, the air outlet is arranged on the surface cover.

In some embodiments, an outer surface of the surface cover is flush with an outer surface of the window frame main body at an adjacent location.

In some embodiments, the window frame main body is provided with an air inlet layer, an air outlet layer and a spacer layer arranged between the air inlet layer and the air outlet layer, and the air outlet layer is provided with an openable surface cover.

In some embodiments, the spacer layer includes a heat insulation layer and a barrier layer.

In some embodiments, the air inlet is arranged at a back portion of the groove, the air inlet is convex, and an opening of the air inlet faces downward.

In some embodiments, a periphery of the air inlet is surrounded by a sealing groove, a sealing ring is arranged in the sealing groove, and the air purification module abuts against the sealing ring, so that a sealed channel is formed between the air inlet and the air purification module.

In some embodiments, a cross section of the sealing ring is “T”-shaped, a small end of the sealing ring is fitted into the sealing groove, and the air purification module abuts against a large end of the sealing ring.

In some embodiments, the window frame main body is mainly surrounded by two vertical rods and two transverse rods, and the groove is formed by fixedly connecting a U-shaped aluminum material to a middle of the window frame main body.

The present disclosure has the following beneficial effects: through the present disclosure, outdoor air can be purified and blown into the interior to improve an air quality of the interior; by arranging the air purification module inside the window frame main body, an overall structure is simple and compact, an lighting effect of the window cannot be affected, an appearance is simple and aesthetic, and it is also convenient for maintenance and replacement of the air purification module in a later stage. In addition, by arranging the convex air inlet with the downward opening, rainwater cannot enter an inside of the groove. In addition, by arranging the sealing ring, a sealing property of the present disclosure is better. In addition, by arranging a control panel, the present disclosure is more intelligent.

### BRIEF DESCRIPTION OF FIGURES

The present disclosure will be further described below in conjunction with the accompanying drawings and embodiments.

FIG. 1 is a schematic structural diagram of Embodiment 1 of the present disclosure;

FIG. 2 is a schematic diagram of breakdown structures of Embodiment 1 of the present disclosure;

FIG. 3 is a schematic structural diagram of a groove of Embodiment 1 of the present disclosure;

FIG. 4 is a schematic structural diagram of Embodiment 2 of the present disclosure;

FIG. 5 is a schematic diagram of breakdown structures of Embodiment 2 of the present disclosure;

FIG. 6 is a schematic structural diagram of a modified example of Embodiment 2 of the present disclosure;

FIG. 7 is a schematic diagram of breakdown structures of the modified example of Embodiment 2 of the present disclosure;

FIG. 8 is a schematic structural diagram of Embodiment 3 of the present disclosure;

FIG. 9 is a cross-sectional diagram of a cross section of Embodiment 3 of the present disclosure;

FIG. 10 is a cross-sectional diagram of a cross section of a modified example of Embodiment 3 of the present disclosure;

FIG. 11 is a schematic structural diagram of a flat open state of Embodiment 4 of the present disclosure;

FIG. 12 is a schematic structural diagram of a right open state of Embodiment 4 of the present disclosure;

FIG. 13 is a schematic structural diagram of a first connecting rod of Embodiment 4 of the present disclosure;

FIG. 14 is a schematic structural diagram of Embodiment 5 of the present disclosure;

FIG. 15 is a schematic structural diagram of a window frame of Embodiment 5 of the present disclosure;

FIG. 16 is a schematic structural diagram of a window sash of Embodiment 5 of the present disclosure;

FIG. 17 is a schematic diagram of a cross-sectional structure of the window sash of Embodiment 5 of the present disclosure; and

FIG. 18 is a schematic structural diagram of a modified example of Embodiment 5 of the present disclosure.

### DETAILED DESCRIPTION

In the description of the present disclosure, it should be understood that orientation or position relationships indicated by terms such as “center”, “longitudinal”, “transverse”, “length”, “width”, “thickness”, “upper”, “lower”, “front”, “rear”, “left”, “right”, “vertical”, “horizontal”, “top”, “bottom”, “inside”, “outside”, “clockwise”, and “counterclockwise” are based on orientation or position relationships as shown in the accompanying drawings, and are intended to facilitate the description of the present disclosure and simplify the description only, rather than indicate or imply that a device or element mentioned must have a particular orientation or be constructed and operated in a particular orientation, and therefore cannot be construed as a limitation to the present disclosure.

### Embodiment 1

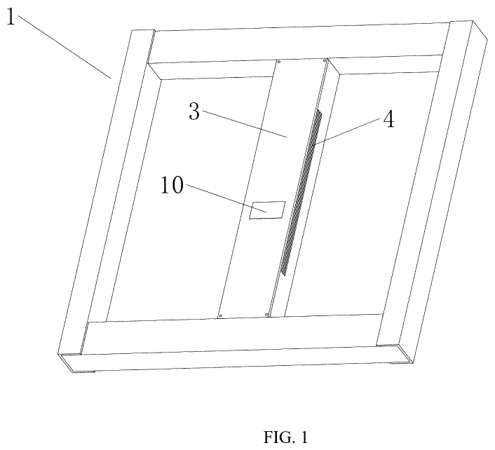

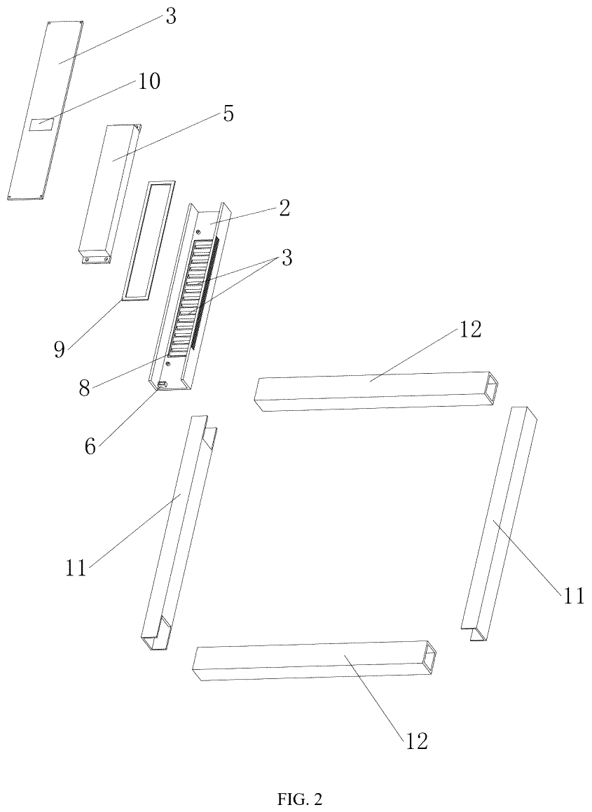

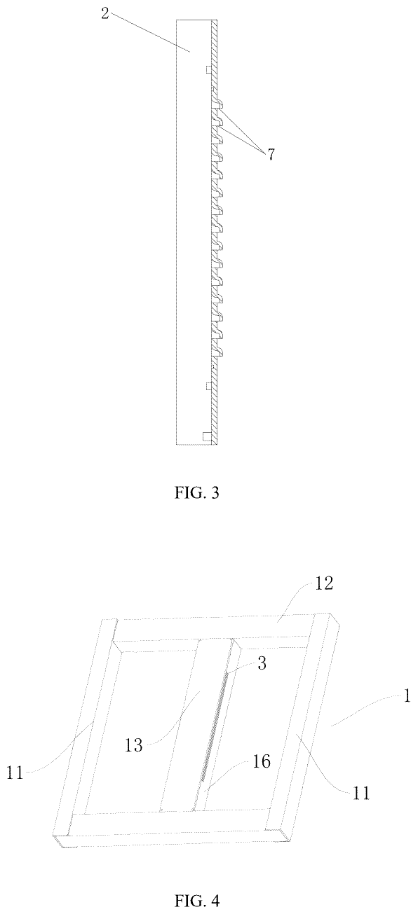

Referring to FIG. 1 to FIG. 3, provided is a fresh air purification window, including a window frame main body 1. The window frame main body 1 is provided with a groove 2, an open end of the groove 2 is covered with a surface cover 13, and the surface cover 13 can be fixed by locking, gluing or clamping. The groove 2 can be arranged at an edge or a middle position of the window frame main body 1 according to needs. A side of the groove 2 close to an exterior is provided with an air inlet 3, and a side of the groove 2 close to an interior is provided with an air outlet 4. It can be understood that the air outlet 4 can be arranged on the surface cover 13 and can also be arranged on a side wall of the groove 2, as long as the air outlet 4 can blow a purified air into the interior. An air purification module 5 and a power connector 6 are arranged inside the groove 2, and the air purification module 5 is electrically connected to the power connector 6. The air purification module 5 is provided with an air inlet end and an air outlet end 14. The air inlet end of the air purification module 5 is in communication with the air inlet 3, so that the outdoor air can be sucked into the air purification module 5 through the air inlet 3. The air outlet end 14 of the air purification module 5 is in communication with the air outlet 4, so that the purified air in the air purification module 5 can be blown out from the air outlet 4.

In this embodiment, the outdoor air can be purified and blown into the interior to improve an air quality of the interior; and by arranging the air purification module 5 inside the window frame main body 1, an overall structure is simple and compact, a lighting effect of the window cannot be affected, an appearance is simple and aesthetic, and it is also convenient for maintenance and replacement of the air purification module 5 in a later stage.

In some embodiments, a plurality of air inlets 3 are provided and are arranged at a back portion of the groove 2. The air inlet 3 has a convex shape formed by stamping, and an opening 7 of the air inlet 3 faces downward. It can be understood that the air inlet 3 cannot only be formed by stamping, but also by other processing methods, as long as the air inlet 3 is convex and the opening of the air inlet faces downward. This design can prevent rainwater from entering an inside of the groove 2 from the air inlet 3.

In some embodiments, a periphery of the air inlet 3 is surrounded by a sealing groove 8. A sealing ring 9 is arranged in the sealing groove 8. The air purification module 5 abuts against the sealing ring 9, so that a sealed channel is formed between the air inlet 3 and the air purification module 5. By this design, a sealing property of this embodiment is better, and the outdoor air can only enter the interior through the air purification module 5.

In some embodiments, a cross section of the sealing ring 9 is “T”-shaped, a small end of the sealing ring 9 is fitted into the sealing groove 8, and the air purification module 5 abuts against a large end of the sealing ring 9. By this design, the sealing property of this embodiment is better.

In some embodiments, a control panel 10 is arranged on a surface of the window frame main body 1, and the control panel 10 is electrically connected to the air purification module 5. The control panel 10 is configured to control a working state of the air purification module 5. The control panel 10 can also cooperate with a sensor to display air quality indexes such as temperature and humidity. Thus, this embodiment is more intelligent.

In some embodiments, the window frame main body 1 is mainly surrounded by two vertical rods 11 and two transverse rods 12. The groove 2 is formed by fixedly connecting a U-shaped aluminum material to a middle of the window frame main body 1. It can be understood that the U-shaped aluminum material can also be made of other materials, as long as the material is U-shaped. By this design, this embodiment is easier to process and produce and has better economic benefits.

### Embodiment 2

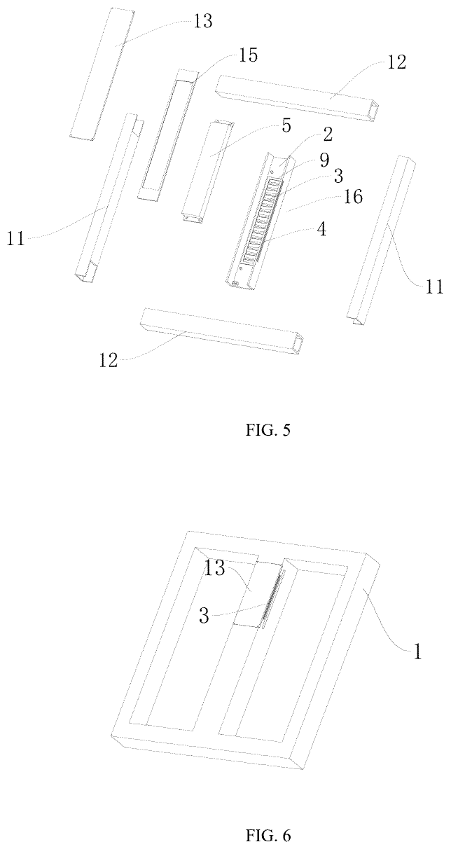

Referring to FIG. 4 and FIG. 5, this embodiment includes a window frame main body 1, and the window frame main body 1 is configured to be fixed to a wall. It should be noted that the window frame main body 1 may be not provided with or provided with a window sash. When the window sash is not provided, the window frame main body 1 is covered with glass to isolate air of an interior and an exterior.

This embodiment further includes an air inlet 3, an air outlet 4 and a groove 2 arranged inside the window frame main body 1 and provided with an open end, and the air inlet 3, the air outlet 4 and the groove 2 are in communication with each other. Specifically, the air inlet 3 is arranged on a side of the window frame main body 1 towards the exterior, and the air outlet 4 is arranged on a side of the window frame main body 1 towards the interior. The air of the exterior can enter the groove 2 from the air inlet 3 and then is discharged to the interior from the air outlet 4.

The air purification module (fresh air system module) 5 is arranged inside the groove 2, the air purification module (fresh air system module) 5 is configured to purify the air, and the air purification module (fresh air system module) 5 is provided with an air inlet end (not shown in the figures) and an air outlet end 14. The air purification module (fresh air system module) 5 can be fixedly connected to an inside of the groove 2, or detachably connected to the inside of the groove 2. The air purification module (fresh air system module) 5 is arranged in a communication channel between the air inlet 3 and the air outlet 4, and the air entering from the air inlet 3 can only be discharged from the air outlet 4 after passing through the air purification module (fresh air system module) 5. The air enters from the air inlet 3, and is purified by the air purification module (fresh air system module) 5 and then discharged from the air outlet 4. Specifically, the air entering from the air inlet 3 will enter the air purification module (fresh air system module) 5 through the air inlet end, and is purified by the air purification module (fresh air system module) 5 and then discharged from the air outlet end 14, and the purified air is finally discharged from the air outlet 4.

An open end is covered with a surface cover 13 detachably. Specifically, the open end is covered with the surface cover 13 through a detachable structure, and the detachable structure may be a fastening structure, a clamping structure, a quick switch structure, a screw fixing structure, or a magnetic suction structure.

A filter screen 15 is detachably arranged inside the groove 2, and the air passes through the filter screen 15 and then is discharged from the air outlet 4. The filter screen 15 is configured to remove pollutants such as dust, particulate matters, bacteria and viruses from the air. The filter screen 15 can be arranged inside the groove 2 through the detachable structure, and the detachable structure may be the fastening structure, the clamping structure, the quick switch structure, the screw fixing structure, or the magnetic suction structure. The filter screen 15 can be arranged in a communication channel between the air inlet 3 and the air inlet end of the air purification module (fresh air system module) 5, and can also be arranged in a communication channel between the air purification module (fresh air system module) 5 and the air outlet 4, and the air needs to pass through the filter screen 15. The air inlet end of the air purification module (fresh air system module) 5 can face towards the exterior or towards a surface passing through the exterior and the interior.

In some embodiments, the filter screen 15 can be inserted along a direction pointing from the interior to the exterior, and the filter screen 15 is mounted in the communication channel between the air inlet end and the air inlet 3.

It can be understood that a filter element can be arranged or not arranged inside the air purification module (fresh air system module) 5. In this embodiment, the surface cover 13 and the filter screen 15 are both detachable, so that the maintenance and service are very convenient for users.

In some embodiments, the window frame main body 1 includes transverse rods 12 arranged oppositely and vertical rods 11 arranged oppositely, and a frame shape is formed by surrounding and splicing the vertical rods 11 and the transverse rods 12. A single side of the window frame main body 1 can be formed by only one transverse rod 12 or vertical rod 11, and can also be formed by splicing a plurality of transverse rods 12 or vertical rods 11 according to length requirements. A U-shaped aluminum material 16 is arranged between the transverse rods 12 or vertical rods 11, and the air purification module (fresh air system module) 5 is arranged inside the U-shaped aluminum material 16. It can be understood that the U-shaped aluminum material 16 can be made of an aluminum material and can also be made of other materials. The U-shaped aluminum material 16 can be arranged parallel to the transverse rod 12 or vertical rod 11. The groove 2 is arranged inside the U-shaped aluminum material 16, the open end of the groove 2 is arranged towards the interior, the air purification module (fresh air system module) 5 is detachably arranged inside the groove 2, and the open end is covered with the surface cover 13. In this embodiment, the window frame main body 1 is formed by splicing, a utilization rate of raw materials is high, and a production process is simple.

In some embodiments, the U-shaped aluminum material 16 is in a shape of a long groove, the groove 2 is surrounded by the U-shaped aluminum material 16 and parts of the transverse rods 12 or vertical rods 11 connected to both ends of the U-shaped aluminum material 16, and the open end of the U-shaped aluminum material 16 is covered with the surface cover 13. By this design, the structure is reasonable, the production process is simple, a space of the groove 2 is large, and a larger air purification module (fresh air system module) 5 can be accommodated.

In some embodiments, the air outlet 4 is arranged on a side wall of the groove 2. The air outlet 4 penetrates through the side wall of the groove 2, and the air can be discharged from the air outlet end 14 of the air purification module (fresh air system module) 5 and passes through the communication channel between the air purification module (fresh air system module) 5 and the air outlet 4, and then is discharged from the air outlet 4.

In some embodiments, a surface of the surface cover 13 is flush with a surface of the window frame main body 1 at an adjacent location. Specifically, the open end of the groove 2 is lower than the surface of the window frame main body 1 at the adjacent location, and after the open end is covered with the surface cover 13, an outer surface of the surface cover 13 is flush with an outer surface of the window frame main body 1 at an adjacent location. By this design, an overall appearance of the window frame main body 1 is simpler and more aesthetic.

In some embodiments, the air purification module (fresh air system module) 5 is detachably arranged inside the groove 2. The detachable structure may be the fastening structure, the clamping structure, the quick switch structure, the screw fixing structure, or the like. This detachable design is more convenient for maintenance in the future.

In some embodiments, the air outlet end 14 of the air purification module (fresh air system module) 5 is covered with the filter screen 15 detachably. In other words, the filter screen 15 is connected to the air purification module (fresh air system module) 5. A periphery of the air outlet end 14 of the air purification module (fresh air system module) 5 is provided with a structure that can be connected to the filter screen 15, the air outlet end 14 of the air purification module (fresh air system module) 5 is covered with the filter screen 15 detachably, and the air discharged from the air outlet end 14 needs to pass through the filter screen 15 and then can be discharged from the air outlet 4. A sealing element can be arranged at a joint of the filter screen 15, so that the joint has a better sealing effect.

In some embodiments, a support part closer to the open end than the air purification module (fresh air system module) 5 is arranged inside the groove 2, the filter screen 15 is detachably connected to the support part, and the air is discharged from the air outlet end 14, and passes through the filter screen 15 and then is discharged from the air outlet 4. In this embodiment, the filter screen 15 is connected to the support part inside the groove 2, the filter screen 15 separates the air outlet 4 from the air outlet end 14 of the fresh air system, and the air needs to be filtered and then can be discharged from the air outlet 4.

In some embodiments, a sealing ring 9 is arranged between the air purification module (fresh air system module) 5 and the air inlet 3. The sealing ring 9 is arranged around the air inlet end of the air purification module (fresh air system module) 5, and the air entering from the air inlet 3 needs to pass through an inner ring of the sealing ring 9. By this design of this embodiment, a sealing property is better, and the external air can be isolated to a greater extent.

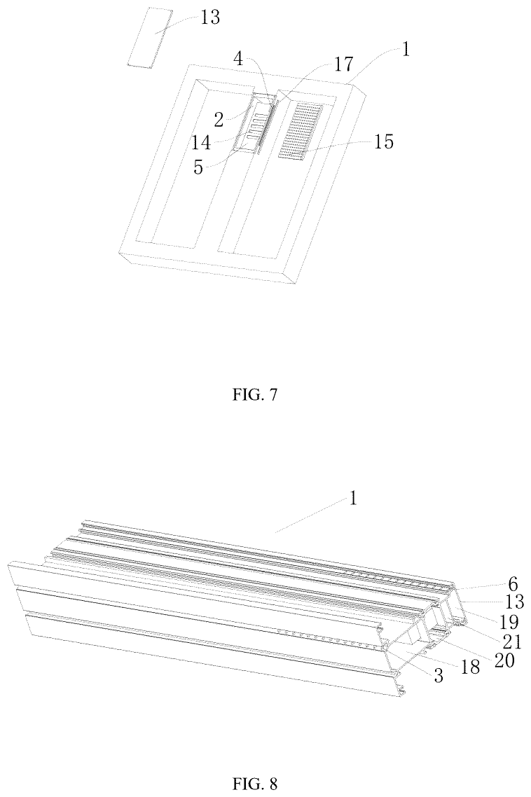

Referring to FIG. 6 and FIG. 7, in a modified example of this embodiment, a plug-in opening 17 penetrates through a side wall of the groove 2, the plug-in opening 17 is arranged between the air outlet 4 and the air purification module (fresh air system module) 5, and the filter screen 15 is detachably inserted into the plug-in opening 17. A shape of the plug-in opening 17 is matched with the filter screen 15, and the filter screen 15 can be inserted into the groove 2 along the plug-in opening 17. When the filter screen 15 is mounted in place, the filter screen 15 is detachably connected to the plug-in opening 17 and can cover the plug-in opening 17 to prevent a leakage of the air inside the groove 2. In this embodiment, the filter screen 15 can be disassembled and assembled without opening the surface cover 13, thereby being more convenient for maintenance and service.

### Embodiment 3

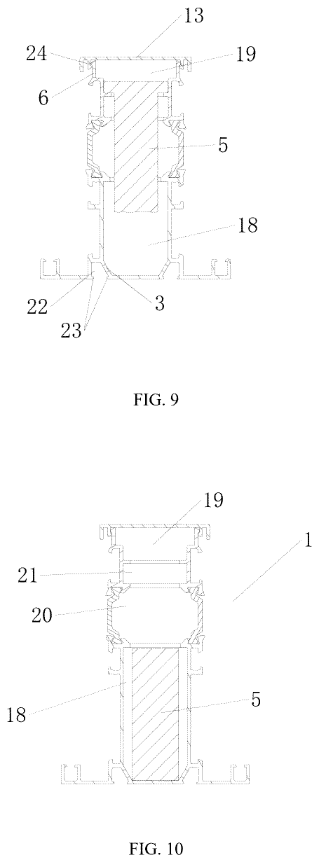

Referring to FIG. 8 and FIG. 9, this embodiment includes a window frame main body 1 and an air purification module (fresh air system module) 5 arranged in the window frame main body 1. The air purification module (fresh air system module) 5 can be controlled in a wireless mode, by a switch, or by arranging a touch screen on the window frame main body 1. The window frame main body 1 can be integrally formed or separately spliced. The window frame main body 1 is provided with an air inlet layer 18, an air outlet layer 19, and a spacer layer arranged between the air inlet layer 18 and the air outlet layer 19. The spacer layer and the window frame main body 1 can be made of same materials or different materials. The spacer layer has a function of heat insulation and/or sound insulation. The air inlet layer 18 and/or the air outlet layer 19 is provided with an openable surface cover 13. Specifically, the surface cover 13 can be fixed by clamping, fitting, locking, and the like. After the surface cover 13 is opened, the air purification module (fresh air system module) 5 can be mounted, maintained or replaced. The spacer layer is provided with a through channel, the air inlet layer 18 is provided with an air inlet 3 in communication with an exterior, and the air outlet layer 19 is provided with an air outlet 4 in communication with an interior. An air enters from the air inlet 3, passes through the air purification module (fresh air system module) 5, and then is discharged from the air outlet 4. In this embodiment, by arranging the openable surface cover 13, it is convenient for mounting, maintenance or replacement. In addition, by arranging the spacer layer, heat insulation and sound insulation properties of this embodiment are improved.

In this embodiment, a fresh air device is deeply integrated with door and window structures to achieve efficient air exchange. Moreover, the concealed mounting of the air purification module (fresh air system module) 5 ensures a concise overall appearance. This embodiment also has good sound insulation and heat insulation properties, and meets the comprehensive pursuit of modern families for comfortable, healthy, energy-saving and aesthetic living environments.

In some embodiments, the spacer layer of the window frame main body 1 includes a heat insulation layer 20 and a barrier layer 21. The barrier layer 21 is configured to insulate sound to improve the sound insulation property of this embodiment. The heat insulation layer 20 is made of a heat insulation material. The heat insulation material is a material with high strength and low heat conductivity, such as PC, PEEK, PSU and PA. The barrier layer 21 is arranged adjacent to the heat insulation layer 20, and at least one barrier layer 21 is provided. Specifically, the barrier layer 21 can be arranged between the heat insulation layer 20 and the air inlet layer 18/air outlet layer 19. By this design, this embodiment has good sound insulation and heat insulation properties.

In some embodiments, the barrier layer 21 and/or the heat insulation layer 20 is filled with a filler. The filler may be polyurethane foam, polystyrene foam, phenolic foam and other fillers with good heat insulation and sound insulation properties. The sound insulation and heat insulation properties of this embodiment are further improved.

In some embodiments, an outer surface of the air inlet layer 18 is provided with an inwards recessed concave groove 22. Notches on both sides of the concave groove 22 are provided with flanges 23. A groove wall of the concave groove 22 is provided with the air inlet 3. By this design of this embodiment, the concave groove 22 and the flange 23 can block rainwater from entering the air inlet layer 18.

In some embodiments, the surface cover 13 is clamped at the air outlet layer 19 through a clamping structure 24, and the air outlet 4 is arranged on a side surface of the air outlet layer 19. By this design of this embodiment, the air outlet 4 is concealed on the side surface, so that the overall appearance is more concise and aesthetic.

In some embodiments, the air purification module (fresh air system module) 5 is fitted and fixed in the channel. By this arrangement of this embodiment, the structure is more compact, and the assembly is more convenient.

Referring to FIG. 10, in a modified example of this embodiment, the air purification module (fresh air system module) 5 is fixed in the air inlet layer 18. The channel can be partially covered, and only a ventilation channel is reserved. By this design, the noise of a fresh air system can be reduced, so that this embodiment is quieter.

### Embodiment 4

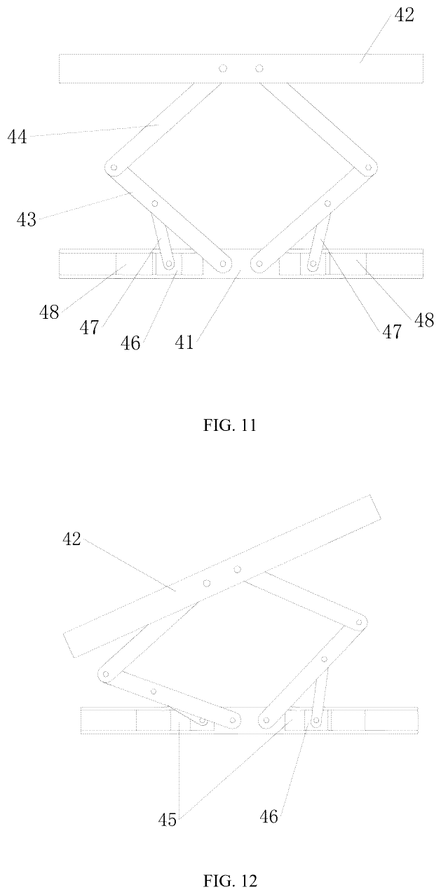

Referring to FIG. 11 and FIG. 12, this embodiment provides a novel sliding support, including a fixed rod 41, a window sash rod 42 and articulated elements. The fixed rod 41 is configured to be fixedly connected with a window frame. The window sash rod 42 is configured to be fixedly connected with a window sash. Two articulated elements are provided and are symmetrically arranged on both sides. The articulated element includes a first connecting rod 43 and a second connecting rod 44 in an articulated connection manner, the other end of the second connecting rod 44 is articulated with the window sash rod 42, and the other end of the first connecting rod 43 is articulated with the fixed rod 41. Articulated points among the fixed rod 41, the window sash rod 42, the first connecting rod 43 and the second connecting rod 44 are articulated through a resistance structure.

In this embodiment, the articulated connection points can be connected by rivets. The rods are staggered to avoid interference during folding of this embodiment. The resistance structure can be locked by rivets to tightly press an articulated joint of each rod mutually to increase the mutual relative rotation resistance for limiting, so that this embodiment can be opened at any angle. Compared with the prior art, this embodiment has a simple and reliable structure, can be opened at more angles and can be horizontally opened outward, opened leftward or opened rightward, users can better control the ventilation effect of windows, and the use is more convenient.

In some embodiments, sliding grooves 45 are arranged at both ends of the fixed rod 41, and a sliding block 46 is slidably arranged inside each sliding groove 45. The sliding block 46 can be made of plastic materials with good self-lubricating properties, such as polyethylene, polyurethane, polytetrafluoroethylene and nylon. The sliding block 46 is articulated with a sliding rod 47, and the other end of the sliding rod 47 is articulated with a middle of the first connecting rod 43. By this design, a load-bearing property of this embodiment can be enhanced, and a rotation range of the first connecting rod 43 can be limited.

In some embodiments, the sliding groove 45 is formed by extending inward from an end of the fixed rod 41, a limiting block 48 is arranged inside the sliding groove 45, the limiting block 48 is arranged on an outer side of the sliding block 46, and the limiting block 48 is configured to limit a sliding route of the sliding block 46. By this design of this embodiment, the sliding block 46 is convenient to assemble. The sliding block 46 and the limiting block 48 are sequentially placed from an end of the sliding groove 45, and the limiting block 48 is fixed at a corresponding position.

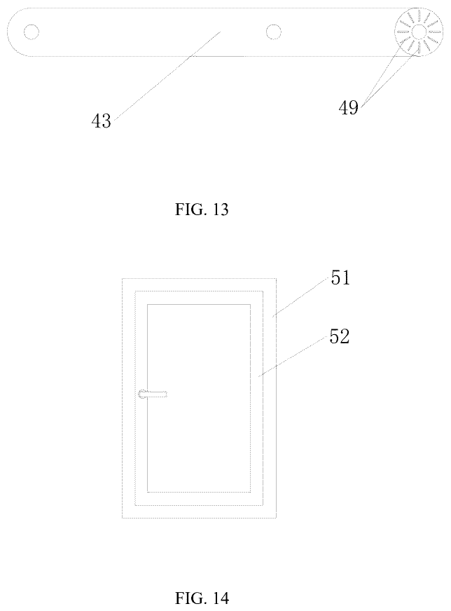

Referring to FIG. 13, in some embodiments, the resistance structure is arranged on a surface where the fixed rod 41, the window sash rod 42, the first connecting rod 43 and the second connecting rod 44 abut against each other. The resistance structure includes a plurality of convex strips 49 arranged in a circumferential array. The convex strips 49 can increase the mutual rotation resistance and provide a better limiting effect. Thus, this embodiment can withstand stronger external forces.

### Embodiment 5

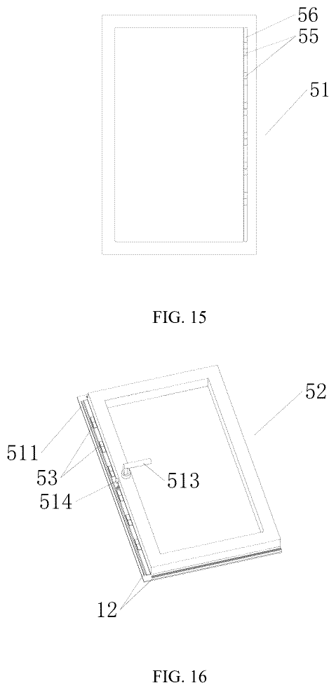

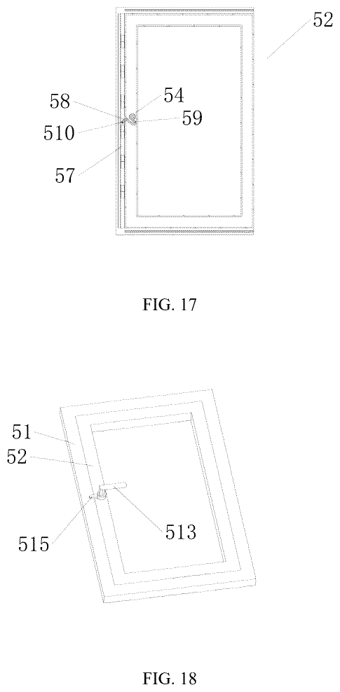

Referring to FIG. 14 to FIG. 17, this embodiment provides a novel casement window, including a window frame element 51 and a window sash element 52 with one side articulated with the window frame element 51. At least one first magnetic element 53 is slidably arranged on the other side of the window sash element 52, and the window sash element 52 is further provided with a switch handle 54. In this embodiment, a plurality of first magnetic elements 53 are provided and are arranged along a length direction of the window sash element 52. The first magnetic elements 53 are connected with the switch handle 54 through a transmission mechanism, and the window frame element 51 is fixedly provided with second magnetic elements 55 matched with the first magnetic elements 53. In this embodiment, the second magnetic elements 55 are fixedly arranged inside a concave part 56 of the window frame element 51. The transmission mechanism may be a structure that performs transmission through a steel wire, a gear, and the like. The switch handle 54 can control the first magnetic elements 53 to slide. In a normal state of the switch handle 54, the first magnetic elements 53 and the second magnetic elements 55 attract each other. Specifically, in this state, at least one magnetic pole of the first magnetic elements 53 and the second magnetic elements 55 is set to attract each other. In an open state of the switch handle 54, the first magnetic elements 53 and the second magnetic elements 55 repel each other. Specifically, in this state, at least one magnetic pole of the first magnetic elements 53 and the second magnetic elements 55 is set to repel each other. That is, the switch handle 54 is twisted, and the switch handle 54 controls the first magnetic elements 53 to slide to enable the same magnetic poles of the first magnetic elements 53 and the second magnetic elements 55 to be aligned so as to generate mutually exclusive forces.

According to this embodiment, when the window needs to be closed, opposite poles of the first magnetic elements 53 and the second magnetic elements 55 attract each other, so that the window closing operation is more convenient and labor-saving; and when the window needs to be opened, the first magnetic elements 53 slide, and the same magnetic poles repel each other, so that the window opening operation is also more convenient and labor-saving. Moreover, in a case that the window sash element 52 is not fixed properly, the window sash element 52 and the window frame element 51 will attract each other through the magnetic force, the window sash element 52 is prevented from colliding back and forth due to wind blowing, and a situation of noise caused by loose locking of the window sash element 52 is also avoided.

In some embodiments, the window sash element 52 is provided with a sliding rail, a sliding strip 57 connected with the transmission mechanism is slidably arranged in the sliding rail, and the sliding strip 57 is fixedly connected with the plurality of first magnetic elements 53. The sliding strip 57 may also be detachably and fixedly connected with the first magnetic elements 53. This design of this embodiment is convenient for maintenance and replacement in a later stage.

Referring to FIG. 13, in some embodiments, the transmission mechanism includes a transmission arm 58, a protrusion part 59 arranged on the switch handle 54, and a cylinder part 510 fixedly arranged on the sliding strip 57. The transmission arm 58 is “V”-shaped. A middle of the transmission arm 58 is articulated with the window sash element 52. One end of the transmission arm 58 abuts against the protrusion part 59. The other end of the transmission arm 58 is provided with a slotted hole, and the cylinder part 510 is slidably connected inside the slotted hole. The switch handle 54 is twisted to enable the protrusion part 59 to extrude the transmission arm 58 to rotate, thereby pushing the sliding strip 57 to slide. The transmission arm 58 and/or sliding strip 57 is provided with a spring, so that a resetting effect of this embodiment is better.

In some embodiments, a periphery of the window sash element 52 is provided with a sealing edge 511, and the sliding rail is arranged on the sealing edge 511. By this design of this embodiment, the structure is simple and compact, and a sealing effect is better.

In some embodiments, the sealing edge 511 is provided with a sealing limiting groove 512, and a sealing strip is arranged inside the sealing limiting groove 512. By arranging the sealing strip, a sealing property of this embodiment is further improved, and a certain anti-collision effect is achieved.

In some embodiments, the first magnetic elements 53 and the second magnetic elements 55 are arranged in opposite positions and opposite magnetic poles. The sliding route of the first magnetic element 53 is half of a length of the first magnetic element. By this design of this embodiment, the magnetic attraction force is stronger, and the effect is better.

In some embodiments, the switch handle 54 includes a lock body arranged inside the window sash element 52 and a hand shank 513 connected with the lock body and arranged outside the window sash element 52. The window frame element 51 is provided with a lock groove, and the lock groove is matched with a spring bolt 14 of the lock body. When the window is closed, under the acting force of magnetic attraction, the window sash element 52 and the window frame element 51 automatically attract each other, and the spring bolt 14 is clamped into the lock groove. Thus, this embodiment can be better locked and is not easily opened by external forces.

Referring to FIG. 18, in a modified example of this embodiment, the switch handle 54 includes a hand shank 513 rotatably connected with the window sash element 52. The hand shank 513 is provided with a press switch 515. The press switch 515 is configured to be locked with the window frame element 51. By this design of this embodiment, the structure is simple, the manufacturing cost is lower, and the economic benefit is better.

The above implementations cannot limit the scope of protection of the present disclosure. Any equivalent modifications and variations made by those skilled in the art without departing from the overall concept of the present disclosure still fall within the scope of the present disclosure.

What is claimed is:

1. A fresh air purification window, comprising a window frame main body, wherein the window frame main body is provided with a groove, an open end of the groove is covered with a surface cover, a side of the groove close to an exterior is provided with an air inlet, a side of the groove close to an interior is provided with an air outlet, an air purification module is arranged inside the groove, an air inlet end of the air purification module is in communication with the air inlet, and an air outlet end of the air purification module is in communication with the air outlet.

2. The fresh air purification window according to claim 1, wherein the air outlet is arranged on a side wall of the groove.

3. The fresh air purification window according to claim 1, wherein the air outlet is arranged on the surface cover.

4. The fresh air purification window according to claim 1, wherein an outer surface of the surface cover is flush with an outer surface of the window frame main body at an adjacent location.

5. The fresh air purification window according to claim 1, wherein the window frame main body is provided with an air inlet layer, an air outlet layer and a spacer layer arranged between the air inlet layer and the air outlet layer, and the air outlet layer is provided with an openable surface cover.

6. The fresh air purification window according to claim 5, wherein the spacer layer comprises a heat insulation layer and a barrier layer.

7. The fresh air purification window according to claim 1, wherein the air inlet is arranged at a back portion of the groove, the air inlet is convex, and an opening of the air inlet faces downward.

8. The fresh air purification window according to claim 1, wherein a periphery of the air inlet is surrounded by a sealing groove, a sealing ring is arranged in the sealing groove, and the air purification module abuts against the sealing ring, so that a sealed channel is formed between the air inlet and the air purification module.

9. The fresh air purification window according to claim 8, wherein a cross section of the sealing ring is “T”-shaped, a small end of the sealing ring is fitted into the sealing groove, and the air purification module abuts against a large end of the sealing ring.

10. The fresh air purification window according to claim 1, wherein the window frame main body is mainly surrounded by two vertical rods and two transverse rods, and the groove is formed by fixedly connecting a U-shaped aluminum material to a middle of the window frame main body.
